(19) United States
(12) Patent Application Publication
(10) Pub. No.: US 2008/0136331 A1
(43) Pub. Date: Jun. 12, 2008

(54) Light-Emitting Element Light Source and Temperature Management System Therefor

(75) Inventor: Lawrence Schmeikal, Coquitlam (CA)

Correspondence Address: CHRISTOPHER J. KULISH, ESQ, HOLLAND & HART LLP, P. O. BOX 8749, DENVER, CO, 80201-8749, US

(73) Assignee: TIR TECHNOLOGY LP, Burnaby (CA)

(21) Appl. No.: 11/929,240

(22) Filed: Oct. 30, 2007

Related U.S. Application Data
(60) Provisional application No. 60/855,437, filed on Oct. 31, 2006.

(51) Int. Cl. H01K 1/62

(52) U.S. Cl. 315/32

(57) ABSTRACT

The present invention provides a light-emitting element light source comprising a system for sensing, and optionally managing, an operating temperature of the light source. In general, the light source comprises one or more light-emitting elements, which may be arranged in one or more groups, one or more arrays or one or more clusters thereof, operatively mounted to respective and/or common substrates. The one or more substrates each generally comprise circuitry operatively coupling the light-emitting element(s) mounted thereto to a light source driving mechanism configured to impart a drive current to the light-emitting element(s). The substrate(s) also comprises one or more thermal probes configured to thermally couple one or more respective and/or combinations of selected light-emitting elements to one or more temperature sensing elements such that an operating temperature of the selected light-emitting element(s) may be sensed, monitored, and optionally controlled in order to maintain desirable light source operating and/or output characteristics.

### FIELD OF THE INVENTION

The present invention pertains to the field of lighting and in particular to a light-emitting element light source and temperature management system therefor.

### BACKGROUND

Advances in the development and improvements of the luminous flux of light-emitting devices such as solid-state semiconductor and organic light-emitting diodes (LEDs) have made these devices suitable for use in general illumination applications, including architectural, entertainment, and roadway lighting. Light-emitting diodes are becoming increasingly competitive with light sources such as incandescent, fluorescent, and high-intensity discharge lamps. Also, with the increasing selection of LED wavelengths to choose from, white light and colour changing LED light sources are becoming more popular.

In general, these light sources comprise one or more LED packages each comprising a substrate to which one or more LEDs are mounted. As the ambient temperature changes, or as the power at which the LEDs are driven changes, the temperature of the LEDs may also change. Such changes in LED temperature may lead to wavelength shifts, flux variations and other such generally undesirable effects. In white light or colour changing LED light sources, these wavelength shifts and flux changes, which may be different for LEDs of a same or different lot, may affect the colour temperature and/or output intensity of the light source. Furthermore, when driving LEDs at high currents (e.g., high brightness LEDs), for instance to maximise an output of the light source, the LED temperature may rise significantly, which may lead to a reduction in LED lifetime and/or operating efficiency.

To reduce temperature-related effects, various techniques have been proposed to extract heat generated by the LEDs in a manner to reduce the operating temperature of the light source. Such techniques may include various types of heatsinks or the like thermally coupled to the light source's LEDs, namely via the LED substrate or the like. Such heat extraction techniques, while providing means for extracting heat form the light source's LEDs, do not enable monitoring of the light-source's operating temperature, which may be used to fine tune the operational parameters of the light source.

Some techniques have been proposed to monitor the operating temperature of LED light sources using thermal sensors disposed on or within the heatsink or thermally conductive substrate to which are mounted the light source's LEDs. For instance, in U.S. Pat. No. 6,617,795, a multichip light-emitting diode package is disclosed as having a thermally conductive support member, at least two light-emitting-diode chips disposed on the support member, at least one sensor disposed on the support member for reporting quantitative and spectral information to a controller relating to the light output of the light-emitting-diodes, and a signal processing circuit, including an analog-to-digital converter logic circuit, disposed on the support member for converting the analog signal output produced by the sensors to a digital signal output.

Also, in United States Patent Application Publication No. 2005/0276052, an LED illumination system is disclosed wherein a heat conducting layer made of diamond is provided on a substrate, on top of which a conductive layer having a predetermined pattern is formed to drive the LED chips operatively connected thereto via the LED electrodes. A connector part of the substrate is provided for operative coupling to a socket, wherein current is supplied to respective LED chips through the conductive layer from the socket, and wherein heat generated in the LED chips is released to the outside of the illumination system from the socket via the conductive layer and via thermal coupling of the substrate's heat conducting layer and a corresponding heat conducting layer disposed within the socket. A temperature sensor centrally disposed on the surface of the heat conducting layer may also be used to monitor temperature increases of the system.

Other such light sources are disclosed in U.S. Pat. No. 6,753,661 for an LED-based white-light backlighting for electronic displays, in U.S. Pat. No. 6,683,421 for an addressable semiconductor array light source for localized radiation delivery, and in United States Patent Application Publication No. 2005/0152146 for a high efficiency solid-state light source and methods of use and manufacture.

In the above references, a temperature sensor is mounted on or within the heatsink or substrate of an LED module, package or array to monitor an operating temperature thereof. While the temperature of the heatsink/substrate can be monitored, changes in the temperature of the LED(s) will have a delayed effect on the temperature of the heatsink/substrate, due in part to the large thermal mass of the heatsink/substrate relative to each LED chip. Such delays may lead to a delayed reaction of the monitoring system, and thereby allow for undesirable thermal effects to occur. For example in certain cases, the delay may be sufficient to allow for significant thermal damage to the LED(s). In addition, when a sensor is mounted to an actively cooled heatsink, a significant temperature differential between the LED(s) and the sensor may be manifested, further complicating correlation between these temperatures. Furthermore, the different temperatures of multiple LEDs may not be determined independently.

In general, the above and other such thermal management methods provide poor or unsatisfactory results, mostly attributed, at least in part, to their configurations relating to measurement of the LED operating temperature. Therefore, there is a need for a light-emitting element light source and thermal management system therefor that overcomes at least some of the drawbacks of known systems.

This background information is provided to reveal information believed by the applicant to be of possible relevance to the present invention. No admission is necessarily intended, nor should be construed, that any of the preceding information constitutes prior art against the present invention.

### SUMMARY OF THE INVENTION

An object of the present invention is to provide a light-emitting element light source and temperature management system therefor. In accordance with an aspect of the present invention, there is provided a light source, comprising: a substrate comprising a substantially thermally isolated probe; a light-emitting element operatively mounted to said substrate thermally coupled to said probe; a temperature sensing element for sensing an operating temperature of said light-emitting element via said probe; and a driving system operatively coupled to said temperature sensing element and said light-emitting element, said driving system configured to provide one or more control signals to the light-emitting element, said one or more control signals configured at least in part using said sensed operating temperature.

In accordance with another aspect of the present invention, there is provided a light source, comprising: a substrate comprising one or more substantially thermally isolated probes; one or more temperature sensing elements, each one of which thermally coupled to one or more respective ones of said one or more probes; one or more light-emitting elements, each one of which operatively mounted to said substrate and one or more of which respectively thermally coupled to each of said one or more probes, wherein a respective operating temperature thereof may be sensed by said one or more temperature sensing elements thermally coupled thereto via said one or more probes; and a driving system operatively coupled to said one or more temperature sensing elements and said one or more light-emitting elements, said driving system configured to provide one or more control signals to the one or more light-emitting elements, said one or more control signals configured at least in part using said sensed operating temperature.

In accordance with another aspect of the present invention, there is provided a light-emitting element package, comprising: a light-emitting element; and a substrate comprising drive circuitry operatively coupled to said light-emitting element and configured to be operatively coupled to a driving system for driving said light-emitting element, and a substantially thermally isolated probe thermally coupled to said light-emitting element and configured to thermally couple same to a temperature sensing element for sensing an operating temperature thereof.

### BRIEF DESCRIPTION OF THE FIGURES

FIG. 1 is a high level diagram of a light-emitting element light source comprising a thermal management system in accordance with an embodiment of the present invention.

FIG. 2 is a high level diagram of a light-emitting element light source comprising a thermal management system in accordance with another embodiment of the present invention.

FIG. 3 is a high level diagram of a light-emitting element light source comprising a thermal management system in accordance with another embodiment of the present invention.

FIG. 4 is a bottom plan view of a light-emitting element light source comprising a thermal management system in accordance with an embodiment of the present invention, wherein dashed lines illustrate partial hidden detail.

FIG. 5 is a cross sectional view of the light-emitting element light source of FIG. 4 taken along line 5-5 thereof.

FIG. 6 is a bottom plan view of a light-emitting element light source comprising a flexible mounting structure and a thermal management system in accordance with another embodiment of the present invention, wherein dashed lines illustrate partial hidden detail.

FIG. 7 is a cross sectional view of the light-emitting element light-source of FIG. 6 taken along line 7-7 thereof.

FIG. 8 is a bottom plan view of a light-emitting element light source, as in FIG. 6, comprising a flexible mounting structure in accordance with an embodiment of the present invention.

FIG. 9 is a bottom plan view of a light-emitting element light source, as in FIG. 6, comprising a flexible mounting structure in accordance with another embodiment of the present invention.

### DETAILED DESCRIPTION OF THE INVENTION

### Definitions

The term “light-emitting element” is used to define a device that emits radiation in a region or combination of regions of the electromagnetic spectrum for example, the visible region, infrared and/or ultraviolet region, when activated by applying a potential difference across it or passing a current through it, for example. Therefore a light-emitting element can have monochromatic, quasi-monochromatic, polychromatic or broadband spectral emission characteristics. Examples of light-emitting elements include semiconductor, organic, or polymer/polymeric light-emitting diodes, optically pumped phosphor coated light-emitting diodes, optically pumped nano-crystal light-emitting diodes or other similar devices as would be readily understood by a worker skilled in the art. Furthermore, the term light-emitting element is used to define the specific device that emits the radiation, and can equally be used to define a combination of the specific device that emits the radiation together with a housing or package within which the specific device or devices are placed.

The terms “colour”, “spectrum” and “spectral output” are used interchangeably to define the overall general output of a light source and/or of a light-emitting element thereof. In general, these terms are used to define a spectral content of the light emitted thereby as perceived by a human subject. Furthermore, each colour is typically associated with a given peak wavelength or range of wavelengths in a given region of the visible or near-visible spectrum (e.g. ultraviolet to infrared), but may also be used to describe a combination of such wavelengths within a combined spectrum generally perceived and identified as a resultant colour of the spectral combination.

The term “operational characteristic” is used to define a characteristic of a light source, and/or of the light-emitting element(s) or other operational component thereof (e.g. light-emitting element(s), thermal management system, feedback system, drive mechanism, etc.), descriptive of an operation thereof: Such characteristics may include electrical, thermal and/or optical characteristics that may include, but are not limited to, a spectral power distribution, a colour rendering index, a colour quality, a colour temperature, a chromaticity, a luminous efficacy, a bandwidth, a relative output intensity, a peak intensity, a peak wavelength, an operating temperature, an efficiency, and/or other such characteristics applicable to the light source, to its light-emitting element(s), and/or to one or more of its other operational components, as will be readily appreciated by the person of ordinary skill in the art.

The term “printed circuit board” (PCB) is used to define circuit boards of a variety of configurations, for example a FR4 board, a metal core printed circuit board (MCPCB), or other circuit boards as would be readily understood by a worker skilled in the art.

As used herein, the term “about” refers to a +/−10% variation from the nominal value, unless referring to a wavelength wherein the term “about” refers to a +/−5 nm variation from the nominal wavelength. It is to be understood that such a variation is always included in any given value provided herein, whether or not it is specifically referred to.

Unless defined otherwise, all technical and scientific terms used herein have the same meaning as commonly understood by one of ordinary skill in the art to which this invention belongs.

The present invention provides a light-emitting element light source comprising a system for sensing, and optionally managing, an operating temperature of the light source. In general, the light source comprises one or more light-emitting elements, which may be arranged in one or more groups, one or more arrays or one or more clusters thereof, operatively mounted to respective and/or common substrates. The one or more substrates each generally comprise circuitry operatively coupling the light-emitting element(s) mounted thereto to a light source driving mechanism or module configured to impart a drive current to the light-emitting element(s). The substrate(s) also comprises one or more thermal probes configured to thermally couple one or more respective and/or combinations of selected light-emitting elements to one or more temperature sensing elements such that an operating temperature of the selected light-emitting element(s) may be sensed, monitored, and optionally controlled in order to maintain desirable light source operating and/or output characteristics.

For instance, the operating temperature of a light-emitting element may be monitored to avoid operating the light-emitting element at a temperature that may lead to noticeable and/or significant damage, and/or cause undesirable output fluctuations, variations and/or changes. For example, as the ambient temperature changes, or as the power at which a light-emitting element is driven changes, the temperature of the light-emitting element may change. Such changes may raise the operating temperature above an acceptable threshold, at which point the operating conditions of the light-emitting element (e.g. efficiency, lifetime, spectral quality, etc.) may deteriorate.

In particular, for some applications, the light-emitting elements of a given light source are driven with as much current as possible to obtain maximum light output. Such high drive currents invariably raise the temperature of the light-emitting elements, which may diminish the expected lifetime of the light-emitting elements and reduce their operating efficiency. This is particularly relevant for high brightness light-emitting elements which dissipate large amounts of heat. Measurement of a light-emitting element's operating temperature may thus be useful in reducing damage to the light-emitting element, in helping prolong its lifetime and/or in maintaining a desired output.

Furthermore, thermal effects may become increasingly important in a light source combining different light-emitting elements, for example of different colours, to produce a combined optical output. Such a light source (e.g. polychromatic light source, white light source, colour changing light source, etc.) may experience noticeable, and possibly detrimental effects when the operating conditions of one or more of its constituent light-emitting elements begins to diverge due to a change in operating temperature. For example, if the spectral output of a given light-emitting element changes due to a temperature increase (e.g. spectral broadening, peak output wavelength shifts, intensity/flux variations and/or fluctuations, etc.), the combined output of the light source (e.g. colour temperature, colour quality, colour rendering index, output intensity, etc.) may also change. For certain polychromatic, white and/or colour changing light source applications, such spectral changes may be important, and as such, should be monitored and rectified as best and as quickly as possible. Furthermore, since thermally induced output variations of individual light-emitting elements may be different for different colours or for light-emitting elements from the same or different lots, it may be beneficial to monitor every light-emitting element, or every group, array and/or cluster thereof independently to provide appropriate compensation when needed.

To reduce such thermal effects, for example to reduce or avoid transient colour shifts, flux variations and/or undue damage, there is provided a light-emitting element light source comprising a thermal management system configured, in accordance with various embodiments of the present invention, to monitor the operating temperature of one or more light-emitting elements of the light source. The light-emitting elements of the light source may be monitored, in accordance with different embodiments, based on different criteria and/or different operating characteristics of the light source and/or light-emitting elements, for example, and depending on the desired output and constraints that may apply thereto.

In particular, and in accordance with different embodiments of the present invention, the following discloses various thermal management systems and configurations comprising one or more thermal probes thermally coupling one or more light-emitting elements of interest to one or more dedicated, common and/or respective temperature sensing elements disposed within the light source. The temperature sensing element(s), which may comprise different types and different numbers of temperature sensing devices that will be readily appreciated by the person skilled in the art (e.g. thermistor, thermocouple, silicon temperature sensor, resistance temperature detector (RTD), and other such thermal sensing means), is disposed in close proximity and in good thermal contact with the one or more light-emitting elements of interest such that a temperature reading accessed via these elements provides a relatively good representation of the actual temperature of the light-emitting element(s) with which the thermal probe is associated. As a result, the embodiments of the present invention allow for a relatively direct and responsive temperature measurement of the light-emitting element(s) of interest within the light source. A light source output control module (e.g. control circuitry, hardware, firmware and/or software) may then use these measurements to adjust a drive current provided to the light-emitting element(s) of interest, and/or to light-emitting elements whose respective and/or combined outputs are associated with, or relevant to, the output of the light-emitting element(s) of interest, and thus control an output thereof thereby reducing a likelihood of damage to the light-emitting element(s) and/or facilitating the maintenance of selected operational and/or output characteristics.

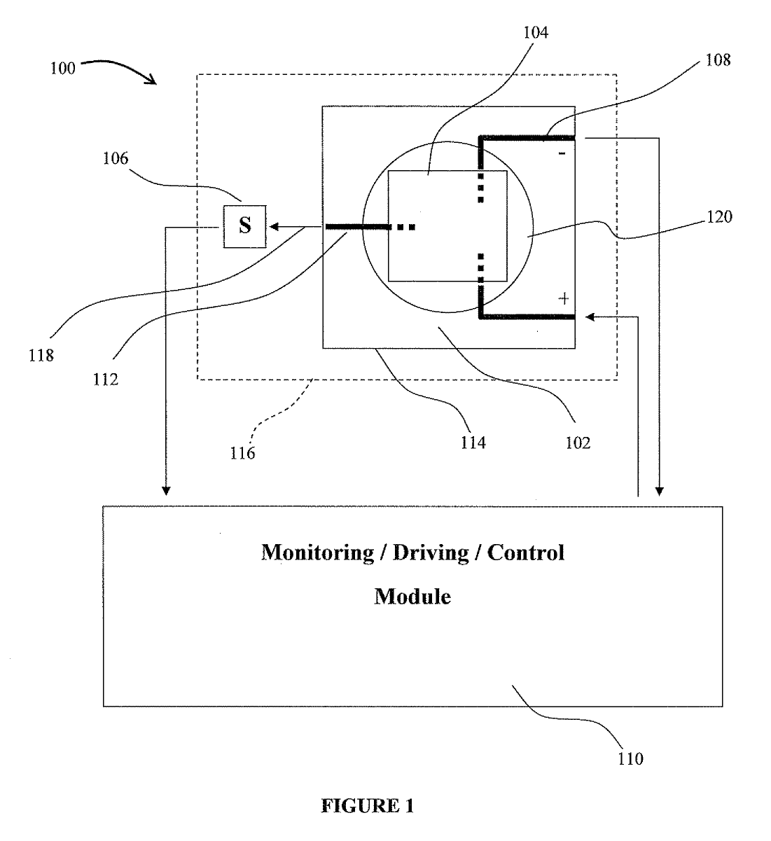

FIG. 1 provides a high level diagram of a light-emitting element light source, generally referred to using the numeral 100, comprising a thermal management system in accordance with one embodiment of the present invention. In general, the light source 100 comprises a substrate 102 and a light-emitting element 104 mounted thereto. The light source further comprises a temperature sensing element 106 for sensing an operating temperature of the light-emitting element 104. In particular, the substrate 102 comprises drive circuitry, schematically depicted as traces 108, operatively coupled to the light-emitting element 104 and leading to a light source driving mechanism or module, integrated in this example within monitoring/driving/control module 110, configured to impart a drive current to the light-emitting element 104 to emit light therefrom. The substrate 102 further comprises a thermal probe 112 thermally coupling the light-emitting element 104 to the temperature sensing element 106. Monitoring, driving and control module 110 is also provided to drive the light-emitting element via drive circuitry 108, while maintaining an acceptable operating temperature, monitored via the temperature sensing element 106 and thermal probe 112.

In one embodiment, the substrate 102 and light-emitting element 104 form part of a light-emitting element package 114 disposed within the light source 100 and operatively coupled to the driving mechanism 110 via a mounting structure 116. As will be apparent to the person skilled in the art, the package 114 may comprise one or more additional elements and features, such as primary optics 120 for example (e.g. lens, diffuser, etc.).

In the embodiment illustrated in FIG. 1, the sensing element 106 is disposed on the mounting structure 116 which provides a thermally conductive probe extension 118 of the thermal probe 112. In this configuration, the sensing element 106 need not form part of the light-emitting element package 114. This may be beneficial when the size of the sensing element 106 and/or the restricted space provided within the package 114 are prohibitively mismatched. Clearly, the person of skill in the art will understand that a similar light-emitting element package may be constructed so to include the sensing element 106 on or within the package 114. A similar light source may also be constructed wherein some or all the elements of package 114 are integrated within the support structure 116.

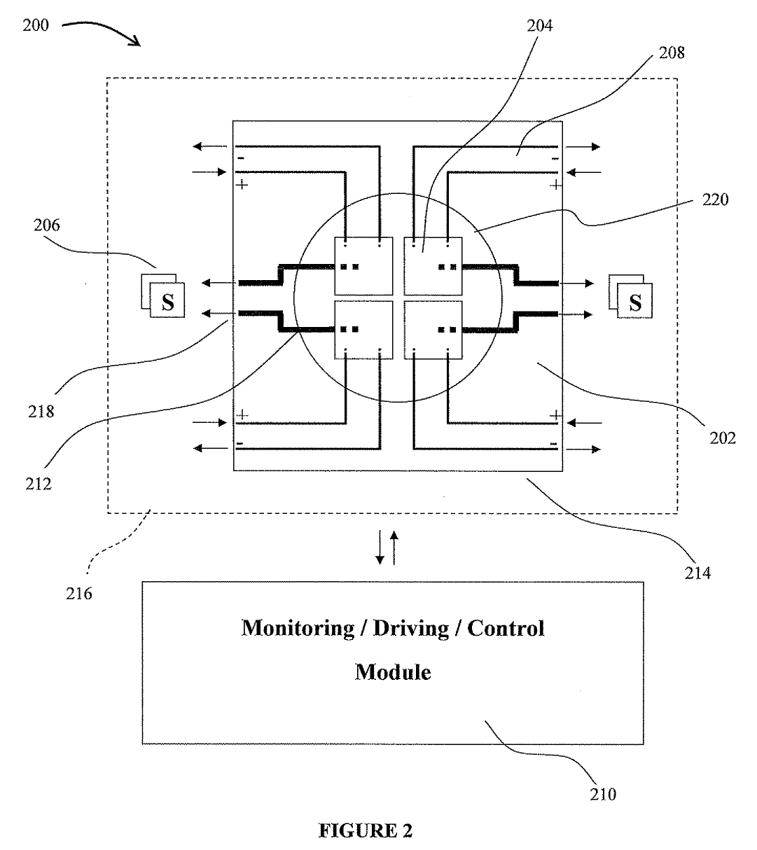

FIG. 2 provides a high level diagram of a similar light-emitting element light source 200, according to another embodiment of the present invention. The light source comprises a substrate 202 and four light-emitting elements 204 mounted thereto. One or more temperature sensing elements 206 for sensing an operating temperature of one or more selected light-emitting elements 204 are also provided. In his embodiment, each of the four light-emitting elements are monitored via the sensing element(s) 206. However, the person of skill in the art will understand that different numbers of light-emitting elements 204 may be selected for monitoring without departing from the general scope and nature of the present disclosure.

In this example, the substrate 202 comprises drive circuitry 208 operatively coupled to the light-emitting elements 204 and leading to a light source driving system 210 configured to impart a drive current to the light-emitting elements 204. The substrate 202 further comprises one or more thermal probes 212, in this embodiment including one thermal probe 212 for each of the four light-emitting elements 204, for thermally coupling each of these light-emitting elements to the temperature sensing element(s) 206. The temperature sensing element(s) 206 are further operatively coupled to the light-source monitoring, driving and control module, which drives the light-emitting elements 204 via circuitry 208, while maintaining an acceptable operating temperature, monitored via the sensing element(s) 206 and thermal probes 212.

The substrate 202 and light-emitting elements 204 may again form part of a light-emitting element package 214 operatively coupled to the driving system 210 via a mounting structure 216, the package 214 comprising one or more additional elements and features, such as primary optics 220 or the like as would be readily understood by the person skilled in the art. Thermally conductive probe extensions 218 may be used to couple the thermal probes 212 to the sensing element(s) 206 disposed on the mounting structure 216.

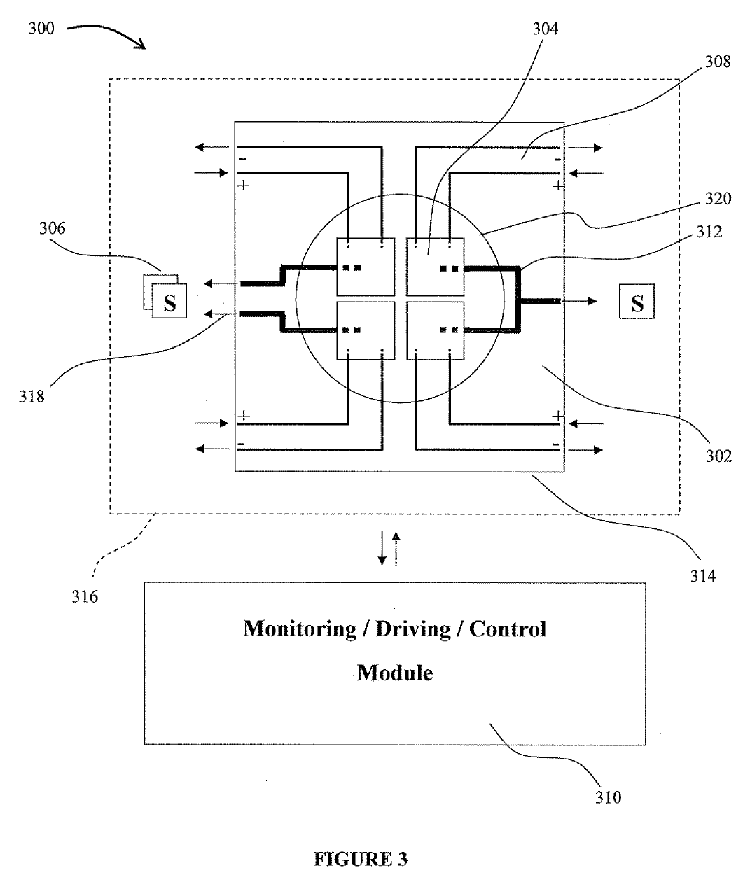

FIG. 3 provides another high level diagram of a light-emitting element light source 300 according to another embodiment of the present invention. The light source comprises a substrate 302 and four light-emitting elements 304 mounted thereto. One or more temperature sensing elements 306 for sensing an operating temperature of one or more selected light-emitting elements 304 are also provided. In this embodiment, each of the four light-emitting elements are monitored via the sensing element(s) 306, as in FIG. 2, however, two of the light-emitting elements 304 are monitored via a common thermal probe 312. Again, the substrate 302 comprises drive circuitry 308 operatively coupled to the light-emitting elements 304 and leading to a light source driving system 310 configured to impart a drive current to the light-emitting elements 304.

The substrate 302 and light-emitting elements 304 may again form part of a light-emitting element package 314 operatively coupled to the driving system 310 via a mounting structure 316, the package 314 comprising one or more additional elements and features, such as primary optics 320 or the like, as would be readily understood by the person skilled in the art. Thermally conductive probe extensions 318 may again be used to couple the thermal probes 312 to the sensing element(s) 306 disposed on the mounting structure 306.

### Light-Emitting Element(s)

The light source may comprise one or more light-emitting elements in various combinations of types, colours and/or sizes. For example, the light source may comprise a single or single type of light-emitting element, for instance comprising light-emitting elements of a single colour, or comprising two or more different types of light-emitting elements providing a combined spectral effect, for instance providing light of a given colour temperature or quality. Examples of the latter may include, but are not limited to, red, green and blue light-emitting elements (RGB), red, amber, green and blue light-emitting elements (RAOB), a phosphor coated white light-emitting element, RGB light-emitting elements and a phosphor coated white light-emitting element, RAGB light-emitting elements and a phosphor coated white light-emitting element and other such combinations as would be readily understood by the person skilled in the art.

As discussed above, in a light source comprising a single colour or type of light-emitting element, in accordance with one embodiment of the present invention, the temperature management system may be used to maintain an operating temperature of the light-emitting element(s) below a given threshold above which operation of the light-emitting element(s) may lead to damages and/or undesirable operating/output conditions (e.g. spectral shifts, output flux variations, fluctuations and/or reductions, reduced lifetime expectancy, reduced efficiency, etc.).

As for a light source combining outputs of different colours and/or types of light-emitting elements, in accordance with one embodiment of the present invention, the temperature management system may otherwise or further be used to maintain overall and/or respective operating temperatures conducive to substantially maintaining a desired combined light source output. For instance, this system may allow the light source to maintain a substantially constant colour temperature, colour quality, colour rendering index, chromaticity, and other such output characteristics readily understood by the person skilled in the art.

Furthermore, the person of skill in the art will understand that the one or more light-emitting elements may be configured in any number and/or types of arrays, groups and/or clusters to provide different effects. Individual light-emitting elements, or groups, arrays and/or clusters thereof may be mounted independently or as part of self-contained light-emitting packages comprising any number of drive circuit, thermal probing and/or optical elements.

### Substrate and Optional Mounting Structure

The one or more light-emitting elements are generally mounted on a substrate or the like, the electrodes of the light-emitting element(s) being operatively coupled to a drive circuitry (e.g. PCB, etc.) provided thereon. In some embodiments, one substrate may be provided for each light-emitting element or for each light-emitting element group, array and/or cluster, thereby defining individual light-emitting element packages or the like. In other embodiments, each light-emitting element may be mounted to a same substrate.

The person of skill in the art will understand that various combinations and substrate configurations may be considered in the present context without departing from the general scope and nature of the present disclosure. For instance, in one embodiment, individual light-emitting elements may be mounted to a common substrate and driven as such by a commonly disposed drive circuitry comprising all necessary elements for driving, and optionally monitoring and/or controlling an optical output of the light-emitting element(s).

In another embodiment, the light-source may comprise one or more light-emitting element packages, each comprising one or more light-emitting elements operatively mounted on a package substrate providing the necessary light-emitting element electrode couplings (e.g. electrode pads, traces, etc.) for driving the light-emitting element(s). Such packages may then be operatively coupled to a mounting structure or the like providing the various drive circuitry elements for driving the packages. For example, in some embodiments, the light source may comprise different light-emitting packages for different colours, such as red, green and blue light-emitting packages, each comprising one or more light-emitting elements of that colour. In other embodiments, the light source may comprise one or more packages each having light-emitting elements of different colours and driven to provide a combined spectral output. These and other such package configurations should be apparent to the person skilled in the art and will thus not be discussed further herein. These and other such variations, however, should not be considered to depart from the general scope and nature of the present disclosure.

In an embodiment comprising one or more light-emitting element packages, or more generally comprising one or more light-emitting elements mounted on respective package, group, array and/or cluster substrates, these respective substrates may be further mounted and operatively coupled to a mounting structure or the like (e.g. PCB, etc.). This mounting structure may generally be operatively coupled to the light source's power supply (e.g. directly or indirectly via a light source driving/monitoring/controlling module circuitry, hardware, firmware and/or software) and comprise different numbers of drivel monitoring/controlling circuitry elements used for operating the light-emitting element(s) on their respective substrates.

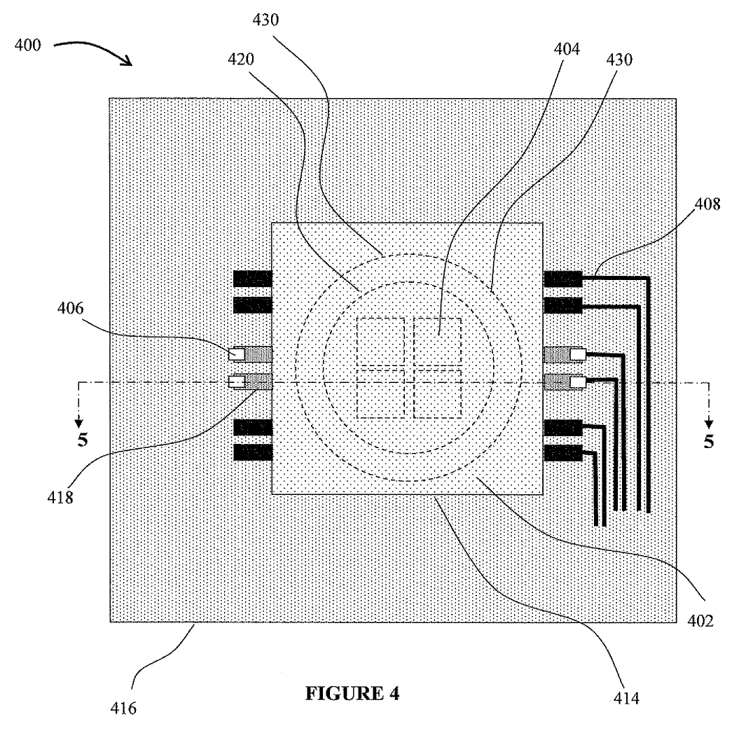

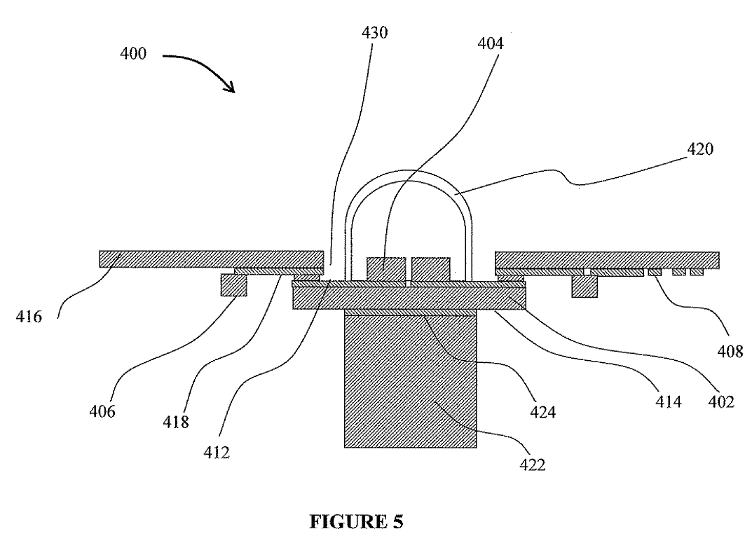

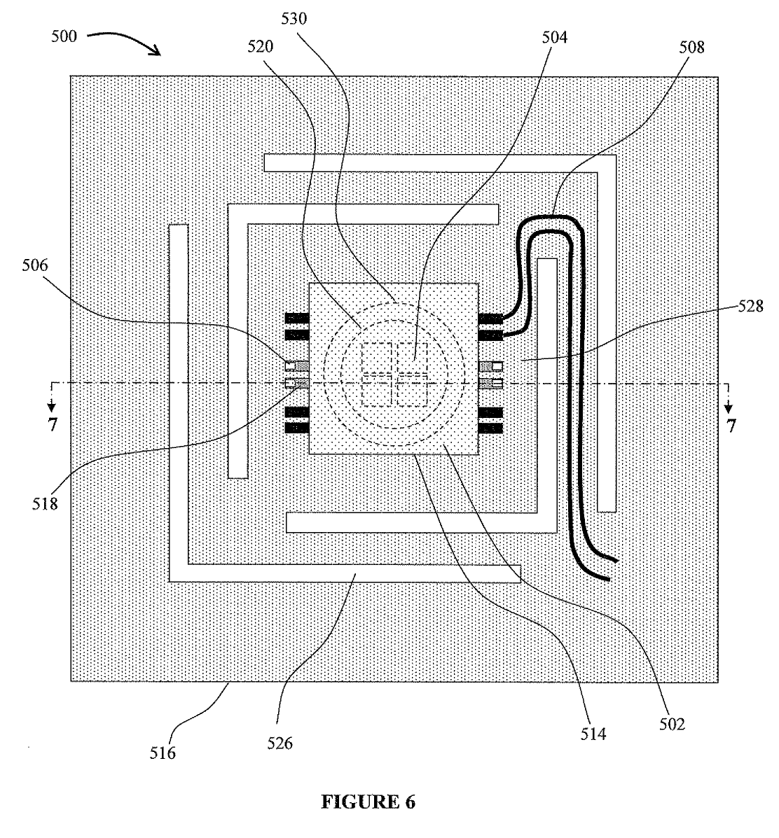

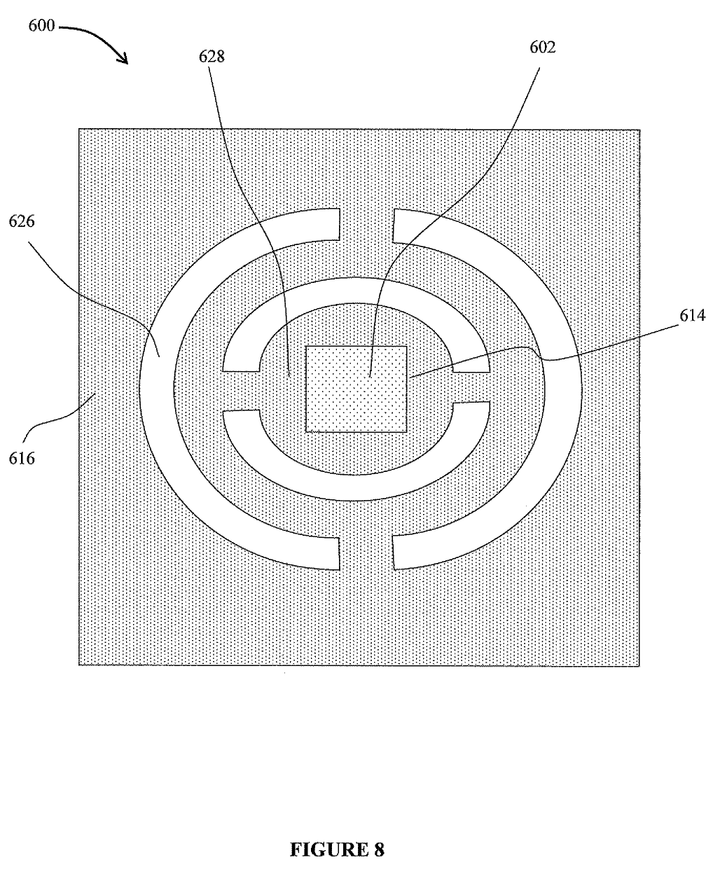

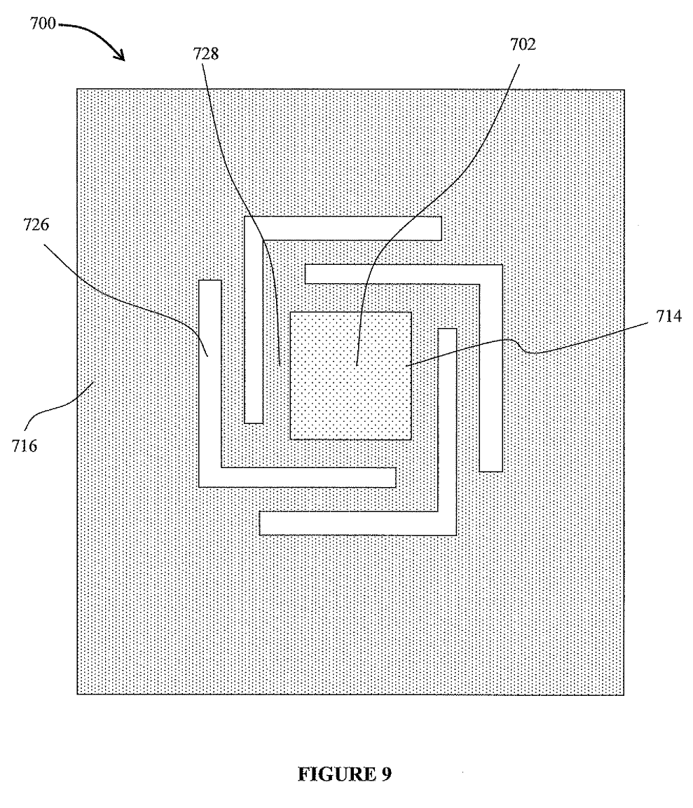

In some embodiments, the mounting structure provides a solid one-piece mounting structure to which are mounted the one or more light-emitting element packages (e.g. see FIGS. 4 and 5). In other embodiments, the mounting structure comprises one or more flexible regions to which are respectively mounted the light-source's one or more packages (e.g. see FIGS. 6 to 9). In these latter embodiments, the flexible region(s) is generally delimited by a series of slots cut through the mounting structure (e.g. L-shaped cuts of FIGS. 6 and 9, arcuate cuts of FIG. 8, etc.) which allow this flexible region, and thus the package mounted thereto, to flex and pivot in various directions relative to the periphery of the mounting structure.

This added structural flexibility may help reduce structural strain between the structure and the package(s) and optionally, further provide the added benefit of isolating the mounted package from the rest of the mounting structure. This added benefit, for example, can provide for a greater thermal isolation of the light-emitting element package from the rest of the mounting structure such that an accurate operating temperature reading of the one or more selected light-emitting elements may be easier to obtain. For instance, if the heat generated by the light-emitting element(s) is permitted to diffuse freely through the entire mounting structure, then a measurement obtained via a sensing element disposed on the mounting structure and thermally coupled to a given light-emitting element's thermal probe, may be less accurate then a similar measurement obtained from a light-emitting element package and sensing element disposed within an at least partially thermally isolated region of the mounting structure. As will be apparent to the person skilled in the art, this added feature need not be included to obtain the desired result, but may nonetheless be considered herein to provide, in some circumstances, improved results.

### Driving System

The light source comprises a driving system operatively coupled to the light-emitting elements via drive circuitry disposed on or within the light-emitting element substrate. Such circuitry may include printed traces on a PCB, wires, and the like operatively coupled to the light-emitting element(s)'s electrodes.

The driving system may further comprise control means (e.g. provided via an integrated drive/control module) for controlling a drive current imparted to the light-emitting element(s) and thereby control an output intensity thereof. Such control mechanisms may be of simple nature for controlling an output intensity of the light source, or may be more complex to fine tune an output colour (e.g. chromaticity, colour temperature, colour quality, etc.) when using light-emitting elements of different spectral outputs, for example.

In one embodiment, the driving and control module is configured to react to an increase in temperature sensed by the temperature sensing element(s) thermally probing one or more selected light-emitting elements, and adjust control signals for example in the form of a drive current, to these light-emitting elements to maintain a substantially constant optical output. In another embodiment the control module adjusts a drive current in order to avoid overheating and thereby reduce the likelihood of damaging the selected light-emitting element(s).

It will be appreciated by the person of skill in the art that various types of control modules may be considered herein, such as micro-controllers, hardware, software and/or firmware implemented devices or circuitry, and the like, without departing from the general scope and nature of the present disclosure. It will also be apparent to this person that various levels of control may be required based on the desired output and level of accuracy required to achieve this output, thereby affecting the complexity of the driving mechanism, and optional control systems to be implemented in association therewith.

### Thermal Probe and Temperature Sensing Element(s)

Each of the light source's one or more thermal probes is generally configured to couple one or more of the light source's one or more light-emitting elements to one or more sensing elements.

For example, in one embodiment, the light source comprises a thermal probe for each of the light source's light emitting elements, and each thermal probe is configured to couple its corresponding light-emitting element to a respective sensing element such that a respective temperature of each light-emitting element may be monitored. In another embodiment, one thermal probe may be used to sample the temperature of a group, array or cluster of light-emitting elements. For example, each light-emitting element of a given colour, or from a same lot or bin, may be probed by a same thermal probe and sensing element, thereby reducing the complexity of the temperature management system while providing a reasonable assessment of the operational temperature of each light-emitting element. Other such examples should be apparent to the person of ordinary skill in the art.

In general, the thermal probes will be configured such that an operating temperature of a light-emitting element coupled thereto is efficiently transferred thereto and communicated to the sensing element. In one embodiment, the light-emitting element is in direct contact with the thermal probe. For example, the thermal probe may comprise a metallic trace or the like (e.g. copper) to which is thermally coupled the light-emitting element, namely via direct contact or via a thermally conductive bonding agent or the like. As such, due to the high thermal conductivity of the probe trace relative to the substrate on which it is disposed, the thermal probe is substantially thermally isolated therefrom thereby allowing heat transferred to the probe to be guided directly to the sensing element with minimal dissipation in the substrate. A thermally isolating bonding agent may further be provided between the probe trace and the substrate to enhance the thermal isolation of the former from the latter.

In one embodiment of the present invention, the thermal probe comprises a microchannel heat pipe or a microchannel thermosyphon configured to transfer heat from the light-emitting element to the sensing element. In this embodiment, due to the thermal transfer capabilities and substantially low thermal resistance of a microchannel heat pipe or a microchannel thermosyphon, the sensing element can be positioned at a location which is a greater distance away from the light-emitting element, when compared to a metallic trace, for example.

The person of skill in the art will understand that various materials and/or configurations may be considered for the thermal probes without departing from the general scope and nature of the present disclosure. For instance, a given thermal probe may comprise both a primary probe and a probe extension. The former could be disposed on the substrate on which the light-emitting element is mounted and coupled to this light-emitting element, for example disposed on a light-emitting element package substrate, while the latter could be disposed on a support structure to which is mounted the light-emitting element substrate (or package), which thermally couples the primary probe, for example via a thermally conductive bonding agent or the like, to a sensing element also disposed on the mounting structure.

As will be apparent to the person of skill in the art, various types of sensing elements may be considered without departing from the general scope and nature of the present disclosure. For example, various temperature sensors, such as a thermistor, thermocouple, silicon temperature sensor, resistance temperature detector (RTD) or the like, may be mounted to the light-emitting element substrate (e.g. on or within a light-emitting element package when such packages are used), or on a light-emitting element or package support structure (e.g. PCB or the like) and coupled to the thermal probe for sensing a temperature of the light-emitting element to which it is coupled. These sensors may then communicate the sensed temperature to a monitoring/control module (e.g. microprocessor or the like) via any suitable means as will be readily understood by the person skilled in the art (e.g. wires, printed circuit traces on a PCB, etc.).

Furthermore, in one embodiment, the thermal probe(s) disposed on the substrate (e.g. package and/or support structure PCB) may be electrically isolated from the drive circuitry configured to power the light-emitting element(s). Alternately, the thermal probe(s) may be in electrical contact with one or more of the drive circuitry traces, for example, providing open extensions thereof. In this configuration, the thermal probe(s) is substantially configured using a low resistance electrical trace and thus does not form part of the drive circuitry to which it is electrically connected.

The invention will now be described with reference to specific examples. It will be understood that the following examples are intended to describe embodiments of the invention and are not intended to limit the invention in any way.

### EXAMPLES

### Example 1

Referring now to FIGS. 4 and 5, a light source, generally referred to using the numeral 400, and in accordance with one embodiment of the present invention, will now be described. The light source 400 generally comprises a substrate 402 and four light-emitting elements, as in elements 404, mounted thereto. The light source 400 further comprises four temperature sensing elements, as in elements 406, for sensing an operating temperature of each of the light-emitting elements 404.

In particular, the top face of the substrate 402 comprises a segment (not shown) of drive circuitry 408 operatively coupled to the light-emitting elements 404 and leading to a light source driving mechanism (not shown) configured to impart a drive current to the light-emitting elements 404. The top face of the substrate 402 further comprises thermal probes 412 (FIG. 5) thermally coupling each light-emitting element 404 to a respective temperature sensing element 406. A monitoring, driving and control module is also provided (not shown) to drive the light-emitting element via circuitry 408, while maintaining an acceptable light-emitting element operating temperature, which is monitored via the sensing elements 406 and thermal probes 412.

In this embodiment, the substrate 402 and light-emitting elements 404 form part of a light-emitting element package 414 disposed within the light source 400 and operatively coupled to the driving mechanism thereof via a mounting structure 416. As will be apparent to the person skilled in the art, the package 414 may comprise a number of additional elements and features, such as an output lens 420 (e.g. hemispherical lens), and other electrical and/or optical element as readily understood by the person skilled in the art.

In this embodiment, the sensing elements 406 are disposed on the underside of the mounting structure 416, which also comprises thermally conductive probe extensions 418 of the thermal probes 412 illustratively coupled thereto via a thermally conductive bonding agent or the like. In this configuration, the sensing elements 406 need not form part of the light-emitting element package 414. This may be beneficial when the size of the sensing elements 406 and/or the restricted space provided within the package 414 are prohibitively mismatched. Clearly, the person of skill in the art will understand that a similar light-emitting element package may be constructed so to include the sensing elements 406 on or within the package 414. A similar light source may also be constructed wherein some or all the elements of package 414 are integrated within the support structure 416.

The light source may further comprise a heatsink 422 or the like (e.g. heatpipe, etc.), thermally coupled to the underside of the package substrate 402 via a thermally conductive bonding agent 424 or the like, and configured to extract heat from the light-emitting element package 414, as is common in the art.

To assemble the light-emitting element package 414 to the mounting structure 416, a hole 430 is provided in the latter. The lens 420 of the package 414 is inserted through the hole 430 and the thermal probes 412 and drive circuitry 408 are appropriately coupled either respectively via direct thermal and electrical contacts, or via thermally and electrically conductive bonding agent(s) (e.g. solder or the like). In this configuration, the light-emitting elements 404 are driven via circuitry 408 disposed, at least in part, on the underside of the mounting structure 416 and on the upside of the package substrate 402, leading to the light-emitting element electrodes (not shown).

The light-emitting elements 404, which are mounted atop a segment of their respective thermal probes 412, transfer heat representative of their operating temperature to these respective probes 412. The probes 412 run atop the substrate 402 and out from the package lens 420, to transfer the representative heat to probe extensions 418, and ultimately to respective sensing elements 406 where the operating temperatures of the light-emitting elements 404 are measured and communicated to the light source monitoring and control module.

The thermal probes 412 are generally not heat sunk and have a low thermal mass. As a result, due to the high thermal conductivity of the probes 412 (e.g. including extensions 418) relative to the substrate on which they are disposed (e.g. including package 414 and support 416 substrates), the thermal probes 412 are substantially thermally isolated therefrom thereby allowing heat transferred to the probes 412 to be guided directly to the sensing elements 406 with minimal dissipation in the substrate(s). A thermally isolating bonding agent may further be provided between the probes 412 and the substrate(s) to enhance the thermal isolation of the former from the latter. For instance, an intervening epoxy adhesive layer having a high thermal resistance may further enhance results.

When using copper thermal probes 412 with conventional PCB materials, for example, the non-conducting PCB material will have a thermal conductivity of about 1500 times less than the copper of the probes. Since the probes 412 are relatively short, the temperature and heat flux in the PCB (substrate) have minimal influence on the temperature of the thermal probes 412, and thus on the temperature measurement provided via the sensing element 406.

### Example 2

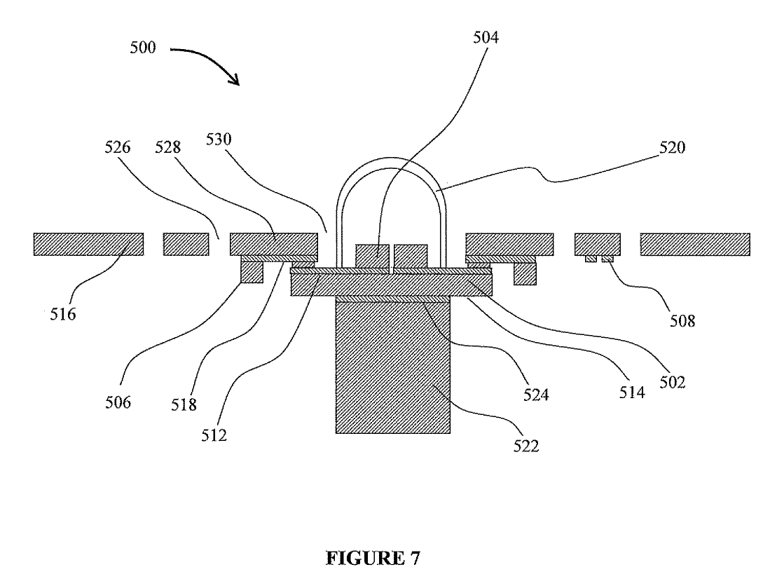

Referring now to FIGS. 6 and 7, a light source, generally referred to using the numeral 500, and in accordance with one embodiment of the present invention, will now be described. The light source 500 generally comprises a substrate 502 and four light-emitting elements, as in elements 504, mounted thereto. The light source 500 further comprises four temperature sensing elements, as in elements 506, for sensing an operating temperature of each of the light-emitting elements 504.

In particular, the top face of the substrate 502 comprises a segment (not shown) of drive circuitry 508 operatively coupled to the light-emitting elements 504 and leading to a light source driving mechanism (not shown) configured to impart a drive current to the light-emitting elements 504. The top face of the substrate 502 further comprises thermal probes 512 thermally coupling each light-emitting element 504 to a respective temperature sensing element 506. A monitoring, driving and control module is also provided (not shown) to drive the light-emitting element via circuitry 508, while maintaining an acceptable light-emitting element operating temperature, which is monitored via the sensing elements 506 and thermal probes 512.

In this embodiment, the substrate 502 and light-emitting elements 504 form part of a light-emitting element package 514 disposed within the light source 500 and operatively coupled to the driving mechanism thereof via a mounting structure 516. As will be apparent to the person skilled in the art, the package 514 may comprise a number of additional elements and features, such as an output lens 520 (e.g. hemispherical lens), and other electrical and/or optical element as readily understood by the person skilled in the art.

In this embodiment, the sensing elements 506 are disposed on the underside of the mounting structure 516, which also comprises thermally conductive probe extensions 518 of the thermal probes 512 illustratively coupled thereto via a thermally conductive bonding agent or the like. In this configuration, the sensing elements 506 need not form part of the light-emitting element package 514. This may be beneficial when the size of the sensing elements 506 and/or the restricted space provided within the package 514 are prohibitively mismatched. Clearly, the person of skill in the art will understand that a similar light-emitting element package may be constructed so to include the sensing elements 506 on or within the package 514. A similar light source may also be constructed wherein some or all the elements of package 514 are integrated within the support structure 516.

The light source 500 may further comprise a heatsink 522 or the like (e.g. heatpipe, etc.), thermally coupled to the underside of the package substrate 502 via a thermally conductive bonding agent 524 or the like, and configured to extract heat from the light-emitting element package 514, as is common in the art.

In addition, the mounting structure 516 comprises a flexible region 528 generally delimited by a series of L-shaped slots 526 cut through the mounting structure 516, to which is mounted the light-source's package 514. This flexible region, and thus the package mounted thereto, may thus Rex and pivot in various directions relative to the periphery of the mounting structure 516. As discussed above, this added structural flexibility may help reduce structural strain between the structure 516 and the package 514 and optionally, further provide the added benefit of isolating the mounted package 514 from the rest of the mounting structure 516. This added benefit, for example, can provide for a greater thermal isolation of the light-emitting element package 514 from the rest of the mounting structure 516 such that an accurate operating temperature reading of the light-emitting elements 504 may be easier to obtain. For instance, if the heat generated by the light-emitting elements 504 is permitted to diffuse freely through the entire mounting structure 516, then a measurement obtained via a sensing element 506 disposed on the mounting structure 516 and thermally coupled to a given light-emitting element's thermal probe 512, may be less accurate then a similar measurement obtained from a light-emitting element package 514 and sensing element 506 disposed within a partially thermally isolated region 528 of the mounting structure 516.

To assemble the light-emitting element package 514 to the mounting structure 516, a hole 530 is provided in the latter. The lens 520 of the package 514 is inserted through the hole 530 and the thermal probes 512 and drive circuitry 508 are appropriately coupled either respectively via direct thermal and electrical contacts, or via thermally and electrically conductive bonding agent(s) (e.g. solder or the like). In this configuration, the light-emitting elements 504 are driven via circuitry 508 disposed, at least in part, on the underside of the mounting structure 516 and on the upside of the package substrate 502, leading to the light-emitting element electrodes (not shown).

The light-emitting elements 504, which are mounted atop a segment of their respective thermal probes 512, transfer heat representative of their operating temperature to these respective probes 512. The probes run atop the substrate 502 and out from the package lens 520, to transfer the representative heat to probe extensions 518, and ultimately to respective sensing elements 506 where the operating temperatures of the light-emitting elements 504 are measured and communicated to the light source monitoring and control module (not shown).

The thermal probes 512 are generally not heat sunk and have a low thermal mass. As a result, due to the high thermal conductivity of the probes 512 (e.g. including extensions 518) relative to the substrate on which they are disposed (e.g. including package 514 and support 516 substrates), the thermal probes 512 are substantially thermally isolated therefrom thereby allowing heat transferred to the probes 512 to be guided directly to the sensing elements 506 with minimal dissipation in the substrate(s). A thermally isolating bonding agent may further be provided between the probes 512 and the substrate(s) 502 to enhance the thermal isolation of the former from the latter. For instance, an intervening epoxy adhesive layer having a high thermal resistance may further enhance results.

When using copper thermal probes 512 with conventional PCB materials, for example, the non-conducting PCB material will have a thermal conductivity of about 1500 times less than the copper of the probes 512. Since probes 512 are relatively short, the temperature and heat flux in the PCB (substrate) will have minimal influence on the temperature of the thermal probes 512, and thus on the temperature measurement provided via the sensing elements 506.

### Example 3

FIGS. 8 and 9 provide different mounting structures 616 and 716 for use in mounting respective light-emitting element packages 614 and 714 similar to those described hereinabove with reference to FIGS. 4 to 7. In the example of FIG. 8, the slots 626 are generally arcuate in nature defining a substantially oblong flexible region 628. In the example of FIG. 9, the slots 726 are L-shaped, defining as in FIG. 6, a square or rectangular flexible region 728. Other slot shapes and configurations providing similar advantages should be apparent to the person skilled in the art and are thus not meant to depart from the general scope and nature of the present disclosure.

The person of skill in the art will understand that the foregoing embodiments of the invention are examples and can be varied in many ways. Such present or future variations are not to be regarded as a departure from the spirit and scope of the invention, and all such modifications as would be apparent to one skilled in the art are intended to be included within the scope of the following claims.

We claim:

1. A light source, comprising:
a substrate comprising a substantially thermally isolated probe;
a light-emitting element operatively mounted to said substrate thermally coupled to said probe;
a temperature sensing element for sensing an operating temperature of said light-emitting element via said probe; and
a driving system operatively coupled to said temperature sensing element and said light-emitting element, said driving system configured to provide one or more control signals to the light-emitting element, said one or more control signals configured at least in part using said sensed operating temperature.

2. The light source according to claim 1, the light source comprising two or more light-emitting elements and respective temperature sensing elements for sensing an operating temperature of each one of said two or more light-emitting elements via respective probes;

3. The light source according to claim 1, the light source comprising two or more light-emitting elements thermally coupled to said probe, said temperature sensing element configured to sense an operating temperature of said two or more light-emitting elements via said probe.

4. The light source according to claim 1, wherein said driving system is operatively coupled to said light-emitting element via a drive circuitry disposed on said substrate.

5. The light source according to claim 1, the light source further comprising a mounting structure to which are distinctly operatively mounted said substrate and said sensing element, said mounting structure comprising a substantially thermally isolated probe extension thermally coupling said sensing element to said probe.

6. The light source according to claim 5, wherein said substrate and said light-emitting element are part of a light-emitting element package operatively coupled to said mounting structure.

7. The light source according to claim 5, said mounting structure comprising a partially thermally isolated region to which is operatively coupled said substrate.

8. The light source according to claim 7, wherein said region comprises a flexible region at least partially delimited by one or more slots formed within said mounting structure.

9. The light source according to claim 1, said probe being coupled to said substrate via a thermally isolating bonding agent.

10. The light source according to claim 1, the light source comprising one or more groups of light-emitting elements and a respective probe and sensing element for sensing an operating temperature thereof.

11. The light source according to claim 1, the light source further comprising a control module configured to control said driving system accounting for said sensed operating temperature in order to minimise thermal damage to said light-emitting element.

12. The light source according to claim 1, the light source further comprising a control module configured to control said driving system in order to substantially maintain one or more operating characteristics of said light-emitting element.

13. A light source, comprising;
a substrate comprising one or more substantially thermally isolated probes;
one or more temperature sensing elements, each one of which thermally coupled to one or more respective ones of said one or more probes;
one or more light-emitting elements, each one of which operatively mounted to said substrate and one or more of which respectively thermally coupled to each of said one or more probes, wherein a respective operating temperature thereof may be sensed by said one or more temperature sensing elements thermally coupled thereto via said one or more probes; and
a driving system operatively coupled to said one or more temperature sensing elements and said one or more light-emitting elements, said driving system configured to provide one or more control signals to the one or more light-emitting elements, said one or more control signals configured at least in part using said sensed operating temperature.

14. The light source according to claim 13, comprising a plurality of light-emitting elements, two or more of which being thermally coupled to a same probe such that an average operating temperature thereof may be sensed by said temperature sensing element thermally coupled thereto.

15. The light source according to claim 13, comprising one or more groups, clusters or arrays of light-emitting elements, one or more light-emitting elements of each one of which being thermally coupled to a same probe such that a representative group, cluster or array operating temperature may be sensed by said temperature sensing element thermally coupled thereto.

16. The light source according to claim 13, comprising a plurality of light-emitting elements, each one of which being thermally coupled to a respective one of said probes.

17. The light source according to claim 13, further comprising a support structure to which are mounted said one or more temperature sensing elements and said substrate, said support structure comprising one or more thermal probe extensions thermally coupling said one or more sensing elements to said respective probes of said substrate.

18. The light source according to claim 17, further comprising an at least partially thermally isolated region to which is mounted said substrate;

19. The light source according to claim 18, wherein said region comprises a flexible region circumscribed by one or more slots cut through said support structure.

20. A light-emitting element package, comprising:
a light-emitting element; and
a substrate comprising drive circuitry operatively coupled to said light-emitting element and configured to be operatively coupled to a driving system for driving said light-emitting element, and a substantially thermally isolated probe thermally coupled to said light-emitting element and configured to thermally couple same to a temperature sensing element for sensing an operating temperature thereof.

21. The light-emitting element package according to claim 20, said probe comprising a metallic trace disposed on said substrate and in direct thermal contact with said light-emitting element.

22. The light-emitting element package according to claim 21, wherein said metallic trace is electrically isolated from said drive circuitry.

23. The light-emitting element package according to claim 20, wherein said probe is disposed on said substrate via a thermally isolating bonding agent or a thermally conductive bonding agent.

24. The light-emitting element package according to claim 20, comprising one or more probes and a plurality of light-emitting elements, one or more of which being thermally coupled to respective ones of said one or more probes.

25. The light-emitting element package according to claim 20, said probe comprising a microchannel heat pipe or a micro channel thermosyphon disposed on said substrate for thermally coupling said light-emitting element and said temperature sensing element.
